(19) United States
(12) Patent Application Publication
(10) Pub. No.: US 2017/0096315 A1
(43) Pub. Date: Apr. 6, 2017

(54) 3D Printer Filament Supply Container Including a Supply Control and Management System

(71) Applicant: Bruce Curtis JACKSON, Auckland (NZ)

(72) Inventor: Bruce Curtis JACKSON, Auckland (NZ)

(21) Appl. No.: 15/178,603

(22) Filed: Jun. 10, 2016

(30) Foreign Application Priority Data
Oct. 5, 2015 (AU) 2015904038

(51) Int. Cl. B65H 49/00; H04W 4/00; H04L 29/06; G05B 19/4099

(52) U.S. Cl. CPC B65H 49/00; G05B 19/4099; H04W 4/008; H04L 63/102; H04L 63/101; G05B 2219/45239

(57) ABSTRACT

The present invention is a container for storing, managing and monitoring the usage time and consumption of a filamentary material consumed by an associated 3D printer during the printer's operation, including a storage quantity of at least one filament, and a power supply, and filament locking means, and filament lock actuation means. The container is universal and can therefore be used with a variety of makes and models of 3D printer hardware. The filament is fed from the quantity of filament through the filament locking means, prior to exiting the container. The filament locking means are normally actuated, thereby preventing feed of filament to emerge from the container unless a predetermined set of unlocking conditions are met to disengage the filament locking means via the filament lock actuation means.

### FIELD OF THE INVENTION

This invention relates to 3D printer systems, and in particular, to a container that securely stores, manages, and supplies a filamentary material to an associated 3D printer under controlled conditions.

### BACKGROUND OF THE INVENTION

3D printer systems are becoming ubiquitous, especially in schools, workshops, libraries, and maker spaces. There are many situations where they are used as a shared communal asset. The 3D filamentary material is consumed by the 3D printer, and therefore its use often needs to be monitored and the costs apportioned to users on a user pays system.

Typically, the filamentary material is contained on a spool and fed to its associated 3D printer. One of the problems associated with this is that the supply of filamentary material to the 3D printer is often not adequately monitored, and no smart technology is used to aid in the management, monitoring and apportioning of the consumption of, the filamentary material associated with a particular 3D printing job. Furthermore, 3D printing jobs can take anywhere from a few minutes, up to multiple hours, or even days, to complete, depending on the size, complexity, and quality settings used on any particular printing job. So it is often important to also log the amount of utilization time that a particular user has taken up in association with a particular 3D printer job.

It is also desirable in many cases for there to be a fleet of 3D printers under a central control. With current 3D filamentary material supply technology, there is no easy way for this central monitoring to accurately determine the consumption of each 3D printer under its management, and to accurately determine which of the associated supplies of 3D filamentary material is getting low, and therefore needs to be replenished. Presently it requires an authorised person to inspect each 3D printer station to ensure it is working within acceptable parameters, and that it has an adequate supply of filament is available. This makes it difficult to maintain an efficient inventory of filament in the appropriate size and colour for a particular 3D printer station

Humidity within the container is another important consideration. Humidity has a significant impact on the performance of the filament during the 3D printing operation. Currently there is no way of determining humidity in each container across the fleet of printer stations being centrally managed. Currently the majority of 3D printer stations do not use proprietary printer filaments, so therefore the spools of filament are left open to the elements. This creates a number of problems:
a) because the filament is statically positively charged, it attracts dust particles to settle upon its surface. Dust is a significant problem in most locations.
b) the filament material tends to be hydrophilic and the higher the level of moisture that it absorbs from the ambient air, the more degraded the filament performance during the 3D printing operation becomes. Conversely, the dryer the filament, the better its performance during the 3D printing operation becomes.

In addition, there are problems associated with the natural elastic resilience of the filamentary material itself. Most supplies of the filamentary material is delivered on spools. The packaging needs to be removed, and the end of the filamentary material located, and fed into the 3D printer. Inexperienced users often mishandle the new spool and end up getting a portion of the filament tangled or kinked, thereby leading to the problem associated with significant spoilage.

It is a goal of the present invention to ameliorate at least some of the aforementioned problems.

### DISCLOSURE OF THE INVENTION

Accordingly, in one aspect, the present invention is a container for storing, managing and monitoring the usage time and consumption of a filamentary material consumed by an associated 3D printer during the printer's operation, including a storage quantity of at least one filament, and a power supply, and filament locking means, and filament lock actuation means. The container is universal and can therefore be used with a variety of makes and models of 3D printer hardware. The filament is fed from the quantity of filament through the filament locking means, prior to exiting the container. The filament locking means are normally actuated, thereby preventing feed of filament to emerge from the container unless a predetermined set of unlocking conditions are met to disengage the filament locking means via the filament lock actuation means.

Preferably the container includes a lockable housing that when closed, completely and securely encloses the storage quantity of at least one filament, the filament locking means, the filament lock actuation means, the electronic circuit board and logic control means, and the lineal measurement device, and thereby only allows authorised persons to unlock the housing to replenish the quantity of filament, or to service any of the components.

Preferably the container includes an electronic circuit board that includes logic control means, and the logic control means are capable of operating the filament lock actuation means once it has determined that the predetermined unlocking conditions have been met.

Preferably the container includes a lineal measurement device, and the filament passes through the lineal measurement device prior to emerging from the container, and wherein the measurement data determined by the lineal measurement device is fed to the logic control means.

Preferably the container includes a digital display that displays information sent to it from the logic control means to inform a user on the container's operational status, and other relevant data pertaining to a particular 3D printing operation.

Preferably the container includes an audible alarm that is controlled by the logic control means, and provides at least one type of alarm tone to a user that informs them of a specific operational condition that is specific to that type of alarm tone, that informs the user that the specific operational condition may affect the particular 3D printing operation, including, but not limited to, when the quantity of filament is nearing depletion and therefore will soon need to be replenished.

Preferably the container includes communication means that are controlled by the logic control means and enable the container to send and receive information to or from a remote computer system, and the remote computer system includes software that manages 3D printer user accounts and only permits authorised users to meet the predetermined unlocking conditions for the particular container, the remote computer is capable of remotely managing multiple containers simultaneously. The multiple containers being remotely managed by the remote computing system may be geographically dispersed with respect to one another.

Alternatively, the communication means are wired.

Optionally the communication means are wireless, and the means to enable a user to securely provide their particular user account credentials includes Near Field Communication (NFC), or Radio Frequency Identification (RFID), biometric data reading means, or a login keypad.

Preferably the container includes physical means to enable a user to provide their particular user account credentials so that they are identified within the remote computer system, and then once identified and authorised by the remote computer system, the logic control means then makes the container operational and records both the time of the operation and the length of filament consumed by a particular 3D printing operation, and sends that data to the remote computer system, whereat it is logged against that particular user's account.

In another form, the present invention is a method of performing a 3D printing operation involving the use of a remote management computer including the steps of:
a. providing a container that is capable of feeding the 3D printer with a feed of filamentary material selected from a storage quantity of at least one filament, wherein said filament is to be consumed during the operation of the 3D printer, and wherein the container includes secure means for a user, who has an account on the remote management computer that is authorised to use the particular 3D printer, to enter their account credentials; and
b. the container securely sends the user's account credentials to the remote management computer, and once the identity of the user has been determined, the container then unlocks the feed of filamentary material, so that it can then be consumed by the 3D printer during its operation; and
c. the container includes means that are capable of logging the duration of time that the user is logged into their account on that particular container, and the quantity of filamentary material fed from the container during that time, and sending that data to the remote management computer, and
d. The remote management computer accrues the information against the particular user's account for the purposes of 3D printer management and tracking and apportioning costs associated with a particular user's 3D printing activity.

### BRIEF DESCRIPTION OF THE DRAWINGS

FIG. 1 is a schematic overview of the present invention.

FIGS. 2 & 3 show isometric views of the universal 3D printer container used in the present invention.

FIG. 4 is an isometric view of the circuit board and attached hardware that is incorporated into the container.

FIG. 5 is an isometric view of an alternative version of the circuit board and attached hardware that is incorporated into the container.

### DETAILED DESCRIPTION OF THE PREFERRED EMBODIMENTS

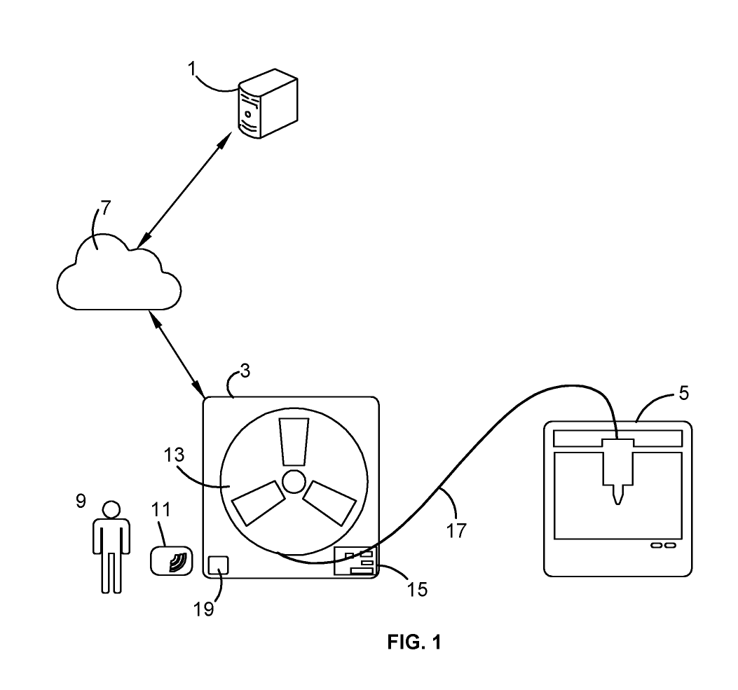

Turning firstly to FIG. 1, we can see a schematic overview of one form of the present invention. In this form a remote management computer 1 is used to run special software that maintains records of user accounts and is also capable of receiving data from, and sending data and operational instructions to, at least one container 3 that is capable of feeding a supply of filament to an associated 3D printer 5. The container 3 is capable of being used in association with practically all 3D printer devices 5. The container 3 contains a quantity of filament, shown in this example as being supported on a reel 13. The filament 17 first passes through the circuit board 15 and associated hardware before it emerges from the container 3 and subsequently fed to the 3D printer 5. The circuit board 15 includes digital communication means, including the options of either wireless or wired connectivity to a network. In addition, the container 3 also includes secure login 19 capabilities. This allows a user 9 to login securely to their account by interacting directly with the container 3. There is a myriad of secure login technologies that could be utilised, including a smart phone app, or a computer or tablet, RFID, NFC, biometric scanning or login keypad. In this example as shown, the user 9 carries an RFID token 11 which securely logs in via an RFID reader 19 accessible on the outer body of the container 3. In addition to the remote management computer 1, the entire printing system may also be managed with the assistance of a cloud management system 7. Either the remote management computer 1 or the cloud management system 7, or a combination of both, can manage multiple containers at the same venue, as well as multiple venues widely dispersed over a geographic area.

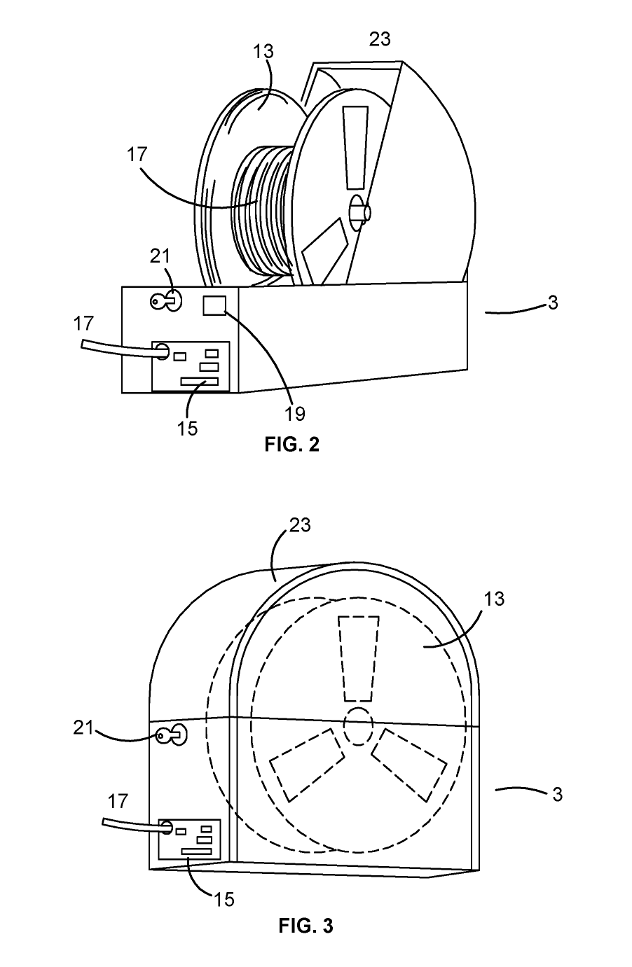

Turning to FIGS. 2 and 3, we are shown further detail of the container 3. In this example of the invention, the container includes a hinged lid 23 that can be moved between a fully closed and fully open position. In FIG. 2 the lid is shown in the fully open position. This enables authorised service personnel to access the internals of the container 3 so that they can replenish the supply of filament 17 that is supported on the reel 13. When the lid 23 is in the fully closed position, as shown in FIG. 3, the lid 23 is locked shut via keylock 21. In preferred embodiments, the container 3 includes a digital display and an audible alert. Neither are shown in the present figures. The digital display provides the user with account and usage details, as well as accrued costs and other information relating to a particular 3D printing operation that utilizes the container 3. The audible alert can give audible indications of a wide variety status conditions. An example of this would be to alert a user that the supply of filamentary material is nearing depletion, and will soon need to be replenished. It may also be set to alert an authorised person that the lid 23 is open.

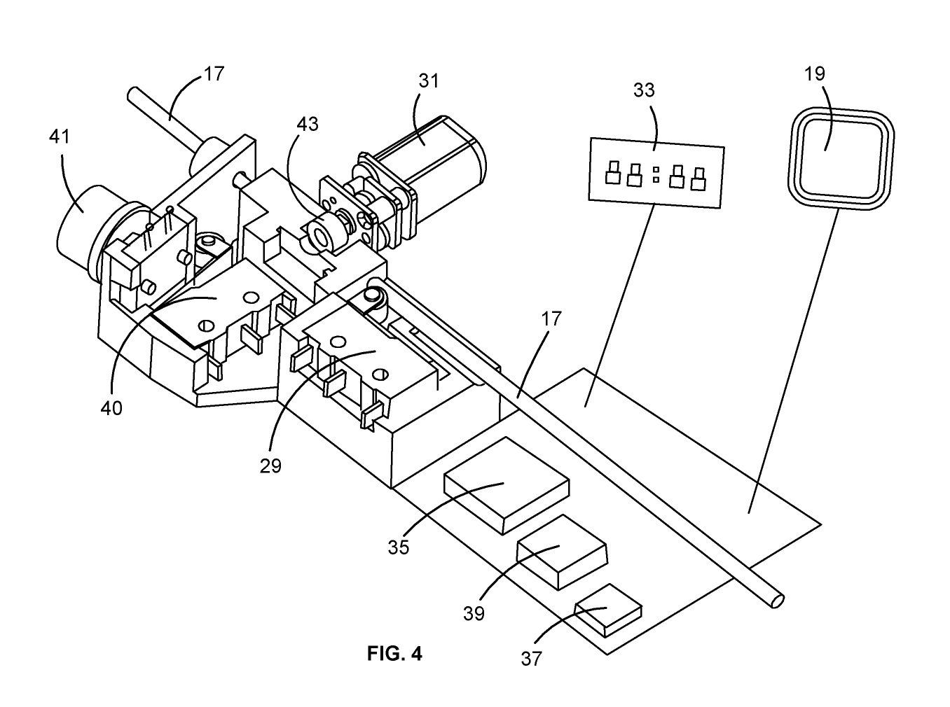

Turning to FIG. 4, we are shown an isometric view of a preferred embodiment of the integrated circuit board 15 and associated hardware that is contained within the container 3. In this view, we can see how the filament 17 transits through the circuit board 15 before exiting the body of the container 3. The circuit board 15 includes a gear motor 31 that drives the wheel 43. The wheel 43 is in direct contact with the filament 17. When the gear motor is activated, it turns the wheel 43 which forces the filament 17 to advance forward. When the gear motor 31 is de-activated, the frictional resistance between the wheel 43 and the filament 17 prevents the filament 17 from advances, and thereby effectively clamps the filament 17 in place. A limit switch 29 is included that detects the presence of the filamentary material 17. Once the rearmost end of the length of filamentary material has passed by the switch, the switch trips and sets off an appropriate alert that enables an authorised person to replenish the supply of filament 17. In this example, the lineal measurement of filament 17 that has been advanced forward via the action of the gear motor 31 and wheel 43 is calculated from the number of revolutions of the wheel 43. The feed switch 40 controls the activation and deactivation of the gear motor 31. The circuit board 15 includes other items used in the system, including the logic control means 35. The logic control means control the operation of the system. The container can be used autonomously, or alternatively, it can be networked to the cloud management system 7 and/or a remote management computer 7. The system may include either wired or wireless network communication means, or a combination of both. An audible alarm 37 is included that is capable of providing preferably a plurality of different alert tones that relate to a variety of events associated with the operation of the system. A humidity sensor 39 is also included that feeds its data into the logic control means 35 and will generate the appropriate alarm if humidity within the container exceeds a set amount. In addition to the alarm 37, the system may also include a digital display 33 that provides system status, consumption, and account related details to the user. Finally, secure login means 19 are incorporated into the container. The user is able to log into their particular user account via the secure log in means 19 which in this example is shown as an RFID token reader.

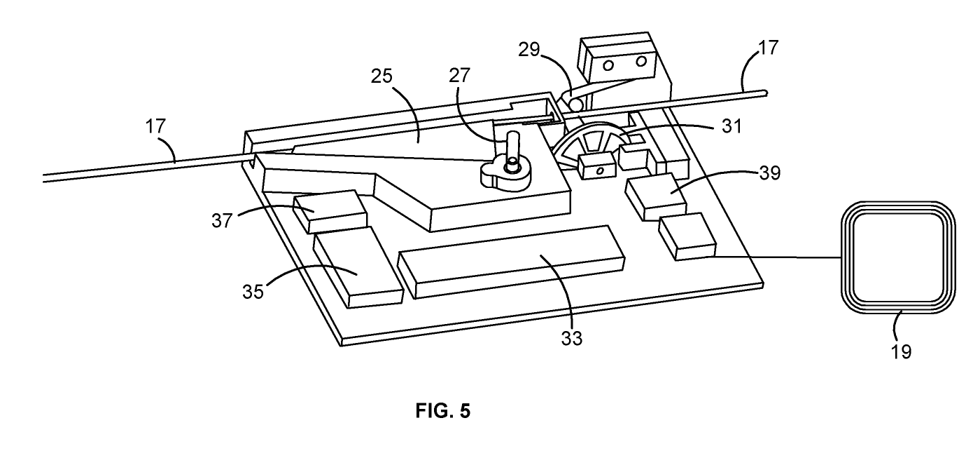

Turning to FIG. 5, we are shown an isometric view of another preferred embodiment of the integrated circuit board 15 and associated hardware, that is contained within the container 3. In this view, we can see how the filament 17 transits through the circuit board 15 prior to exiting the body of the container. The circuit board 15 includes a normally closed lock clamp 25. When in its normal position, it physically clamps down upon the filamentary material with sufficient force to prevent it from being fed to the associated 3D printer hardware. A servo motor 27 is capable of disengaging the clamp 25 when a set of predetermined unlocking conditions have been met. Once the clamp is released, the filament is free to be fed into the 3D printer. A limit switch 29 is included that detects the presence of the filamentary material 17. Once the rearmost end of the length of filamentary material has passed by the switch, the switch trips and sets off an appropriate alert that enables an authorised person to replenish the supply of filament 17. The circuit board 15 also includes a lineal measurement device 31 that is able to accurately determine the lineal length of filamentary material consumed by the 3D printing operation. This information is accrued against the particular user's account. In this embodiment, a digital display 33 is included that is visible on the surface of the container 3 and provides the user with instructional and account related information relating to the particular 3D printing operation. The user is able to log into their particular user account via the secure log in means 19 which in this example is shown as an RFID token reader. The circuit board 15 includes logic control means 35 which maintains 2-way communication with the remote management computer 1 and/or cloud management system 7. The logic control 35 is capable of controlling the variety of items associated with the system, including the operation of the lock clamp 25. An audible alert 37 is also included. Finally, a humidity sensor 39 is included and enables the central management system to monitor humidity across its fleet of containers and to optionally alert a user to the ambient humidity inside the particular container they are preparing to use.

To use the system, a user 9 must first have a user account. This can be managed autonomously by the container 15 itself, or can be managed by either of the remote management system 1 & 7. Once logged iThe user can then go to any 3D printer station under the control and management of the remote management system and securely log on using their credentials by entering them directly into the container 3. The container includes both wired and wireless communication means that enable 2-way communication between the container and the remote management system. Once their credentials are checked and confirmed, the remote management system sends a control signal to the logic control 35 on the circuit board 15 housed inside the particular container 3 that causes it to release the locking clamp 25. Once the clamp is released, the filament 17 is able to move and be fed into the associated 3D printer. A lineal measurement device 31 measures the lineal length of filamentary material 17 fed from the container 3, and feeds that information back to the logic control 35. The duration of usage and the lineal length of filamentary material is accrued by the remote management system against the relevant user account for the purpose of apportioning costs and tracking filament usage.

While the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A container for storing, managing and monitoring the usage time and consumption of a filamentary material consumed by an associated 3D printer during the printer's operation, including:
a storage quantity of at least one filament, and
a power supply, and
filament locking means, and
filament lock actuation means,
wherein the container is universal and can therefore be used with a variety of makes and models of 3D printer hardware, and wherein a filament, selected from the storage quantity of at least one filament, is fed through the filament locking means prior to exiting the container, and wherein the filament locking means are normally actuated, thereby preventing the feed of filament to emerge from the container unless a predetermined set of unlocking conditions are met to disengage the filament locking means via the filament lock actuation means.

2. A container as defined in claim 1 wherein the container includes a lockable housing that when closed, completely and securely encloses the storage quantity of at least one filament, the filament locking means, the filament lock actuation means, the electronic circuit board and logic control means, and the lineal measurement device, and thereby only allows authorised persons to unlock the housing to replenish the quantity of filament, or to service any of the components.

3. A container as defined in claim 1 wherein the container includes an electronic circuit board that includes logic control means, and the logic control means are capable of operating the filament lock actuation means once it has determined that the predetermined unlocking conditions have been met.

4. A container as defined in claim 3 wherein the container includes a lineal measurement device, and the filament passes through the lineal measurement device prior to emerging from the container, and wherein the measurement data determined by the lineal measurement device is fed to the logic control means.

5. A container as defined in claim 3 wherein the container includes a digital display that displays information sent to it from the logic control means to inform a user on the container's operational status, and other relevant data pertaining to a particular 3D printing operation.

6. A container as defined in claim 3 wherein the container includes an audible alarm that is controlled by the logic control means, and provides at least one type of alarm tone to a user that informs them of a specific operational condition that is specific to that type of alarm tone, that informs the user that the specific operational condition may affect the particular 3D printing operation, including, but not limited to, when the quantity of filament is nearing depletion and therefore will soon need to be replenished.

7. A container as defined in claim 3 wherein the container includes communication means that are controlled by the logic control means and enable the container to send and receive information to or from a remote computer system, and the remote computer system includes software that manages 3D printer user accounts and only permits authorised users to meet the predetermined unlocking conditions for the particular container, and wherein the remote computer is capable of remotely managing multiple containers simultaneously, and wherein the multiple containers being remotely managed by the remote computing system may be geographically dispersed with respect to one another.

8. A container as defined in claim 7 wherein the communication means are wireless.

9. A container as defined in claim 7 wherein the communication means are wired.

10. A container as defined in claim 7 wherein the container includes physical means to enable a user to provide their particular user account credentials so that they are identified within the remote computer system, and then once identified and authorised by the remote computer system, the logic control means then makes the container operational and records both the time of the operation and the length of filament consumed by a particular 3D printing operation, and sends that data to the remote computer system, whereat it is logged against that particular user's account.

11. A container as defined in claim 8 wherein the means to enable a user to securely provide their particular user account credentials includes Near Field Communication (NFC), or Radio Frequency Identification (RFID), biometric data reading means, or a login keypad.

12. A method of performing a 3D printing operation involving the use of a remote management computer including the steps of:
a. providing a container that is capable of feeding the 3D printer with a feed of filamentary material selected from a storage quantity of at least one filament, wherein said filament is to be consumed during the operation of the 3D printer, and wherein the container includes secure means for a user, who has an account on the remote management computer that is authorised to use the particular 3D printer, to enter their account credentials; and
b. the container securely sends the user's account credentials to the remote management computer, and once the identity of the user has been determined, the container then unlocks the feed of filamentary material, so that it can then be consumed by the 3D printer during its operation; and
c. the container includes means that are capable of logging the duration of time that the user is logged into their account on that particular container, and the quantity of filamentary material fed from the container during that time, and sending that data to the remote management computer, and
d. The remote management computer accrues the information against the particular user's account for the purposes of 3D printer management and tracking and apportioning costs associated with a particular user's 3D printing activity.
